(19) United States
(12) Patent Application Publication
(10) Pub. No.: US 2005/0079905 A1
(43) Pub. Date: Apr. 14, 2005

(54) Exercise system with graphical feedback and method of gauging fitness progress

(76) Inventor: Mark H. Martens, Falls Church, VA (US)

Correspondence Address: MILES & STOCKBRIDGE PC, 1751 PINNACLE DRIVE, SUITE 500, MCLEAN, VA, 22102-3833, US

(21) Appl. No.: 11/000,920

(22) Filed: Dec. 2, 2004

Related U.S. Application Data
(63) Continuation-in-part of application No. 09/933,576, filed on Aug. 21, 2001.

(51) Int. Cl. A63F 9/24; G06F 17/00; A63F 13/00; G06F 19/00

(52) U.S. Cl. 463/1

(57) ABSTRACT

A system and method for providing visual feedback to a user of an exercise machine for gauging fitness progress of the user. The system provides a user of an exercise machine with a virtual competition in which the user competes against virtual competitors based on past performances. The system may raise the level of performance required to win the virtual competition, and may also lower the level of performance required if the user is not performing well on a particular day. The system attempts to keep the user engaged and motivated to achieve desired fitness goals by providing real-time performance data and historical performance data displayed in a graphical manner coupled with the entertainment and excitement of a competition.

### CROSS REFERENCE TO RELATED APPLICATIONS

This application is a continuation-in-part of application Ser. No. 09/933,576, filed on Aug. 21, 2001 in the name of Mark Martens.

### BACKGROUND OF THE INVENTION

This present invention relates generally to exercise equipment and more particularly to a cardiovascular exercise machine having a display system to provide a visual gauge of fitness progress and a method for gauging fitness progress.

Exercise machines, as used herein, include fitness bikes, treadmills, step machines, stair machines, rowing machines, cross country skiing machines and/or the like. Exercise machines have been equipped with a device comprising a combination of a visual display and a controller. For example, are known to have attached thereto a media system. The media system may provide capability to play compact discs and cassette tapes, as well as providing small television screens on which to view television programming, movies, and/or the like. In such machines, there is no electronic connection between the media system and the exercise machine. The media system merely provides the capability to watch TV and play music during workouts.

In another known exercise machine, monitors are attached in order to vary and monitor parameters of the workout such as resistance, target heart rate, time elapsed, distance covered, current pulse rate, caloric burn ‘rate’, and total calories consumed during the workout. The monitors may typically display numeric variables in pre-formatted areas, and grids of dots that are either lit, to produce bars of various heights. Once a user finishes the workout, summary information may be briefly displayed in numeric format, and then may disappear.

In yet another example of known exercise equipment, exercise machines are provided with Internet connectivity for use while exercising. This particular system may also provide for individual user identification, recording of total or cumulative miles of ‘exercise’ achieved for each identified user, and permit a user to view his or her own summary of historical totals while in the system. However, this display may be in the form of numerical data, possibly in a spreadsheet format.

There may have been products or services where a computer projects a paced competitor that proceeds at a specific pre-selected speed. In other systems a user may compete against other users. Although these systems may harness the competitive spirit, or alleviate exercise boredom for some, these systems suffer from several limitations.

For example, conventional exercise displays may not allow a user to determine whether the user is performing better, or worse, than in the past. For example, a user may want to determine if he or she can cycle (or run) faster, further, or easier today as compared with yesterday, or last week. Further, conventional exercise displays may not allow a user to determine how much energy was expended during their present workout as compared with a previous workout, except in total, and after they complete the workout.

A common concern of exercise machine users is whether they are improving their fitness. Conventional exercise machine displays may not allow a user to determine if the user is improving his/her fitness, and, if so, by how much, and in what way.

Another common concern of exercise equipment users is whether they are more fit currently than they were in the past. Conventional exercise displays may not allow a user to determine, for example, whether the user is more fit today than the user was yesterday, last week, or last month, and, if so, by how much and in what way.

Yet another concern of users of exercise machines may be what needs to be done immediately in order to reach a desired performance level. Conventional exercise machine displays may not allow a user to determine how much harder the user has to exercise in order to reach a desired performance goal. Further, conventional exercise machine displays may not allow a user to determine how much harder the user should exercise immediately in order to improve performance.

A still further concern of exercise machine users may be determining average performance during exercise sessions and what the trend of the average is.

Conventional exercise displays may not allow a user to determine how tired the user was at a similar point in a previous workout. Further, conventional exercise machine displays may not allow a user to determine if a user is capable of beating the user's fastest, or best, time.

A major concern, of exercise machine users is determining whether there has been any measurable progress made toward the user's goal of improving their fitness.

A difficulty in exercise programs may be that regular rigorous exercise is hard to maintain. For example, many people may start exercise programs with great enthusiasm, but may quickly lose motivation after a few weeks. According to research approximately 60% of new members joining gyms to start an exercise program may give up after 3 months. At the beginning of a new year, consumers may spend thousands of dollars on exercise machines, and, within a few months, the exercise machines may be gathering dust in a basement. For many people, it may be difficult enough to get motivated to start exercising in the first place, and may be even more difficult to maintain high exercise intensity for a full 20-30 minute workout. Although many people may be highly motivated to exercise for self-improvement, for most, aerobic activities, particularly using exercise machines, may be hard work, tedious, repetitive, uncomfortable, and/or boring.

Conventional visual systems on or around exercise equipment attempt to address this problem. While some visual display systems may alleviate the tedium felt during repetitive motion exercise, they may also be distracting to the workout itself.

Although conventional systems may make the user less bored during exercise, but they may not make the user less bored by exercise. For example, watching a great basketball game on a television display system while exercising may be entertaining, but it will not help a user get a better workout. In fact, quite the opposite may result. Such systems may entertain the user, but at the cost of further disconnecting the user from the exercise activity. They may also impair a connection to the exercise activity and an ability to engage in intense workouts.

Activities like television or surfing the net, available on exercise equipment, may make one more likely to come to the gym, but because they are actually distracting the user from the workout, they reduce the intensity of the exercise program. Yet for fitness improvements it may be critical to push limits, and for this an increase in workout intensity may be necessary. In other words, it is not enough to be ‘less bored’ during exercise activity for fitness improvement. Rather, a user may need to feel more invested in the activity itself.

Exercise frequency is important, but without workout intensity improvements may be very limited. For intense workouts, motivation and concentration may be critical. Because conventional systems may actually make it more difficult to concentrate and workout hard, users may experience limited fitness improvements even after using such exercise machines for long periods of time. As a result they may get both bored and disappointed, leading to a possible discontinuation of the exercise activity.

Conventional exercise machine display systems may periodically display limited variables such as the users current heart rate in numerical format. In contrast, the present invention allows the user to view graphs showing continuously changing variables (such as pulse rate) in real-time from the initiation. This allows a user to continuously monitor and gauge relative effort, intensity, and duration, as well as progress and self-improvement.

### SUMMARY OF THE INVENTION

An exemplary embodiment of the present invention provides a solution to the problem and limitations of conventional display system discussed above by creating a real-time visual feedback environment in which the user may exercise in a virtual competition. In the virtual competition, a user exercises against his/her own previous workouts as “shadow competitors”, while continuously receiving updated graphical presentations of relevant performance and physiological parameters, based on the current workout and in relation to those of previous workouts.

An exemplary embodiment of the present invention comprises a computer, or processor attached to an exercise machine, a visual display device, processes, software, drivers, graphical animation methods, and a remote server(s) and database. This embodiment of the present invention provides a method and system for measuring, recording, and providing graphical and/or visual feedback to users of the relevant parameters of their current workouts, juxtaposed with those of previous workouts, on exercise machines. The system may work in an equivalent fashion, with minor adjustments, for many different cardiovascular exercise machines.

In an exemplary embodiment of the present invention, the display system of the invention may be attached to an exercise bicycle. In this embodiment, the local system visual display mechanism (for example, a monitor attached to an exercise bike) presents a small cyclist figure to representing the current workout of the user. The figure may move along a “virtual track” on the display screen, varying in relation to the rate at which the user is pedaling. The invention may also produce several other “shadow competitor” cyclist figures. The other shadow competitors may represent actual and/or theoretical workouts previously recorded, which may be averages. Each of the shadow competitors may move along the virtual track at a rate in accordance with the speed at which the user pedaled, during an actual workout that the shadow competitor is based on. In addition to reproducing into the current virtual environment, actual workouts previously recorded, the invention also generates mathematical or even theoretical shadow competitors to represent, say, the weekly or monthly average, or for such things as the personal best time.

In addition to creating the ‘virtual competition’, an exemplary embodiment of the present invention may provide a continuous record of all workout variables from the beginning of the workout to the present time in graphical format. For example, the user may see not only what his current pulse rate is, but the user may see a line graph of exactly what it is at each point in the workout and how the user's pulse rate has been changing throughout the workout. To allow for comparisons with previous workouts an exemplary embodiment may also provide the user with an input device, such as, for example, a touch screen, to bring up the same graphical representations for each and any of the “shadow competitors.” These graphs may be juxtaposed, or overlaid, with the current graph for that variable to provide the user with immediate up to date visual comparisons. This allows the user to readily see, for example, how his current pulse rate has changed compared to his/her pulse rate on a previous workout, up to this same point in the workout.

The visual juxtaposition, or overlay, of workout shadows allows the user to easily and immediately see whether the user is ahead or behind a particular shadow(s), and by how much. The graphical juxtaposition, or overlay, of workout variables such as pulse rate also allow the user to readily ascertain the relative intensity and relative fitness compared to specific previous workouts, at each point throughout the workout. This feedback may keep a user involved in a workout and provide an incentive to work harder.

The invention, in an exemplary embodiment, thus provides visual representations in real-time, of ‘up-to-date’ workout intensity and progress or change over time, as the user is achieving it. The present invention may be designed to make the workout more personal, more interesting, more compelling, and/or provide the greater motivation. Visually, the system may mimic watching oneself compete on television. Although previously exercise may have been a solitary and boring activity, the visual feedback system of the present invention on relative workout performance, in real time, may provide for an interesting competition, and also provide immediate visual feedback on many aspects of the workout as well as improvement over time. The present invention may overcome the limitations of conventional systems by combining physical and/or physiological feedback relative to previous workouts, which may provide psychological reinforcement for increasing intensity and self-improvement.

In an exemplary embodiment of the present invention, each user competes against himself. This may be important for psychological reasons. Unlike competing against others, this is a competition that all of users can win most of the time, providing more encouragement and therefore incentive to try harder. In fact, on any given day, each user may have a chance to win their race. However, each time they do, it raises the performance bar for next time. The more often one beats a shadow competitor, the better performance it takes to beat the shadow competitor the next time, but also the more the user pushes his/her body to improve it's capabilities. Conversely, after a couple of slow weeks, a user may be temporarily discouraged, but the performance bar is being lowered, which gives the user a better chance of doing well the next time period. It is this finely tuned ‘automatic adjusting of the performance bar’ that an exemplary embodiment of the present invention provides, which constructs an appropriate schedule of positive psychological reinforcement and therefore encouragement. To maximize motivation, an exemplary embodiment of the present invention may make each workout challenging, but not discouragingly so, for each user based on their abilities and past performance.

An exemplary embodiment of the present invention shows measurable progress towards a fitness goal in a way that may also provide an incentive and reward for effort. By providing feedback in a current workout, the system may encourage a user in real-time, when the user's motivation is most vulnerable.

In other words, the system and method of the present invention may make a computer game out of workouts. Millions of people play computer games long and often, and, perhaps, even obsessively. Although this may sound like unproductive or frivolous behavior on a computer game, it is exactly the behavior to encourage for exercise activities. Therefore, the system and method of the present invention may be designed to take advantage of the same psychological forces by creating the same environment. Only in this game the “joystick” is an exercise machine, the “skill” is workout effort, and the only way to win the game is to workout harder. Normally obsessive gaming leads to “sore thumbs”, but by attaching a different game console and joystick, this invention actually harnesses obsessive behavior to get “sore muscles”, and fitness improvements.

In an exemplary embodiment, the graphical workout feedback system (GWFS) of the present invention comprises a remote data system, a local system, and a method of connecting the remote and local systems.

The remote system comprises a remotely located server(s) with installed operating system(s), accessible by a large number of local systems, a database, and transmission and communication protocols, and operating system, software technologies, and application programming interfaces (APIs).

The local system comprises a computer and monitor connected to an exercise machine, a set of sensors and drivers for measuring user workout activities/motions on the machine and transmitting them to the system in electronic form, transmission and communication protocols, interface/query programs for retrieving workout data from remote database, and graphics/animation functionality. The graphics/animation functionality comprises visual representations of current and previous actual or mathematically constructed workouts in the same time/space reference (e.g. figures representing the current exercise activity ‘competing against ones own previous workout/time’), graphical presentations of different parameters of current and previous workouts, such as distance covered, resistance, and pulse rate, up to date, in real time, and throughout the duration of the workout.

The connectivity between local and remote systems may be a wired or wireless network, such as, for example, the Internet.

### BRIEF DESCRIPTION OF THE DRAWINGS

The present invention will be described with reference to the accompanying drawings, wherein:

FIG. 1 is a block diagram of a conventional client server database architecture with internet connection;

FIG. 2 is a block diagram of a server side software architecture showing a relational database management system in relation to an operating system;

FIG. 3 is a block diagram of an exemplary client software architecture in relation to a network architecture for the present invention;

FIG. 4 is a block diagram of an exemplary exercise machine network in accordance with the present invention;

FIG. 5 is a diagram of an exemplary graphical user interface display in accordance with the present invention;

FIG. 6 is a diagram of an another form of a graphical user interface display in accordance with the present invention;

FIG. 7 is a block diagram of an exemplary relational database design in accordance with the present invention; and

FIG. 8 is a flowchart of an exemplary method for providing graphical workout feedback in accordance with the present invention.

### DETAILED DESCRIPTION

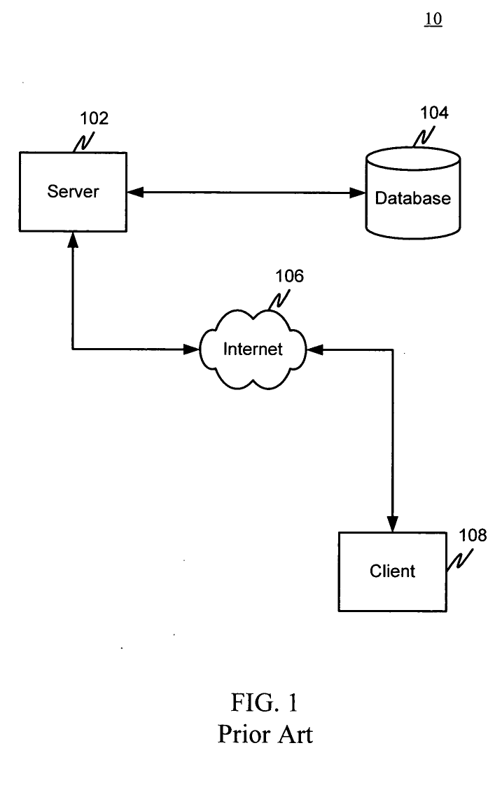

Referring to FIG. 1, there is illustrated a block diagram of a conventional client server database system with Internet connection. In particular, client server system 10 comprises a server 102, a database 104, an Internet network 106, and a client 108.

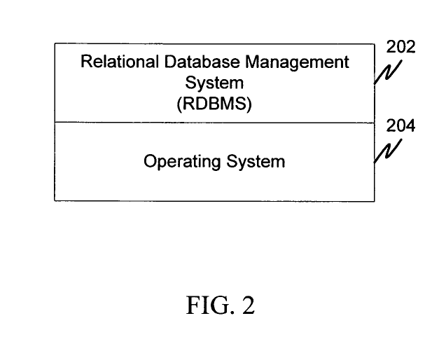

FIG. 2 is a block diagram of a relational database management system in relation to an operating system. In particular, a relational database management system 202 is coupled to an operating system 204.

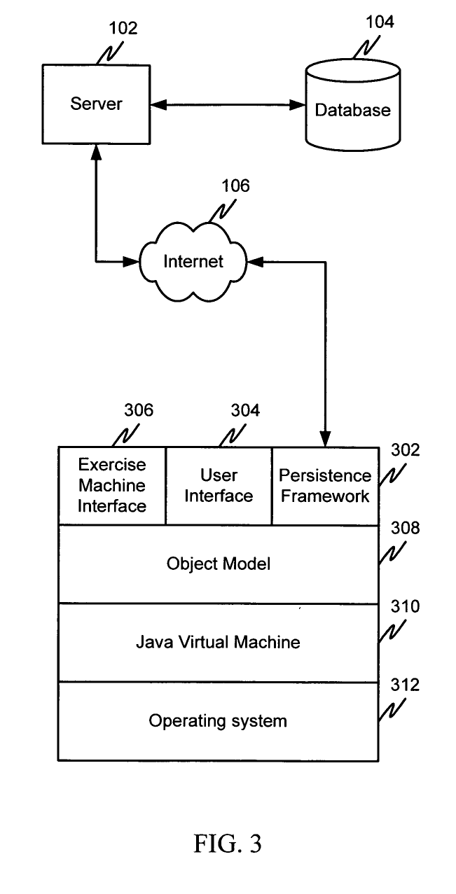

FIG. 3 is a block diagram of an exemplary client architecture in accordance with the present invention. In particular, a client architecture comprises a persistence framework (e.g. Hibernate) 302, a user interface (e.g. SWING) 304, an exercise machine interface 306, a relational database design (e.g. MYSQL) 308, a java virtual machine 310, and an operating system (e.g. Linux) 312.

In operation, the persistence framework 302 provides a mechanism for the GWFS application data to be permanently saved. The user interface 304 provides the graphical user interface functionality. The exercise machine interface 306 provides an interface to the sensor coupled to the exercise machine and/or the user. The object model 308, java virtual machine 310, and the operating system 312 provide various software support services that enable the GWFS application to operate.

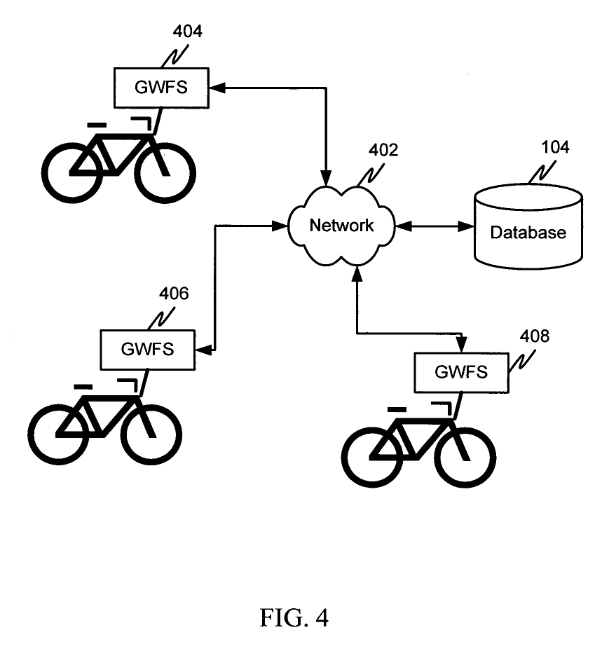

FIG. 4 is a block diagram of an exemplary exercise machine network in accordance with the present invention. In particular, a database 104 is linked to a network 402. Exercise machines equipped with the GWFS (404,406, and 408) are linked to the network 402.

In operation, the exercise machines equipped with the GWFS (404,406, and 408) store and retrieve data in the database 104 via communication across network 402. The network 402 may be a wired or wireless network.

Further, the system provides for individual user identification and confirmation. User input is accomplished by the local part of the system, the GWFS units (404, 406, and 408), which are attached to the exercise machines. The GWFS units (404, 406, and 408) prompt the user to enter information identifying the user and intended workout parameters. The visual display of the GWFS units (404,406, and 408) provides this functionality through a touch-sensitive monitor screen keyboard that is displayed in response to the user initiating the system. The touch-sensitive screen keyboard is a preferred, but not the only, method for the local system interface, and is desirable primarily for eliminating the need for a physical keyboard. The system is initiated when a user touches the application icon, or when a user commences to use the equipment in the normal manner. If the user requests GWFS functionality the local system sends a query to the remote database 104, via the network 402 using identification information input by the user. As soon as the local part of the system authenticates the user from the remote database, it returns their previous workouts, allows the user to select form those workouts, and then it creates a ‘virtual competition’ environment on a selected area of the visual display (monitor). The system generates different virtual competition environments depending on the particular exercise machine it is attached to. For illustrative purposes the current description assumes it is attached to an exercise bike. In this case, the virtual competition environment consists of a road, or track (circular, linear, or other shaped course) in which cycling figures can be depicted. The GWFS units (404, 406, and 408) depict the current workout as a figure on a bike moving along the track at a speed commensurate with the rate at which the user pedals on the exercise machine. The system moves the ‘cyclist’ around/along the virtual track much in the same way a video game does. But the GWFS in this configuration responds to pedal motion not to input from a joystick or game console. This functionality is accomplished using various graphical animation methods.

When the remote server (not shown) receives the identification request from the local GWFS units (404,406, and 408), it verifies the user identification and returns a package of data to the local site, i.e. the GWFS units (404, 406, and 408). This package of data is typically a standardized profile of the user's previous workouts.

The initial standard data package depends on the recency and availability of previous workout data. The GWFS units (404,406, and 408) temporarily store this data on the local hard drive, and then use this data to generate a variety of ‘shadow competitors’ and add them to the visual presentation of the virtual competition. One shadow competitor is generated for each previous workout retrieved. For example, if the individual has already been working out for a minute by the time the local system receives the data package, then the GWFS presents each shadow competitor at the logical location on the virtual track that was reached, one minute after the start of each respective workout. Each shadow competitor is color coded for easy visual identification and with a color intensity in reverse proportion to the recency of that workout. For example, if a shadow represents a workout from a month ago, the shadow would have a very low color intensity. The local system also generates shadow competitors for theoretical workouts such as ‘the previous weeks average’, the ‘previous months average’, ‘weekly average to-date’, ‘personal best’, and others. A preferred number of shadow competitors, depending on several conditions, is 5-10. The standard competition includes the previous five workouts, plus a shadow for the average (of those five), plus a shadow for the user's personal best time for that workout distance. In any case, it is likely that the virtual competition will function best based on a total of less than 10 total shadow competitors. However, the GWFS units (404, 406, and 408) also generate more shadow competitors in response to subsequent user requests.

The GWFS units (404, 406, and 408) recreate the exact movement over time of those previous workouts, but depict them as shadow competitors moving along the same virtual track as the current workout. Each shadow is depicted either behind or ahead of the current workout figure, and each other, at all times in exact proportion to their relative performance from the initiation of the workout. In other words, the GWFS units (404, 406, and 408) take all these workouts that occurred in reality at different times, and recreates them, in the same track, as if they were happening simultaneously. It should be appreciated that the graphical presentation may be in two-dimensional graphics, or in three-dimensional graphic representations. With a result that the GWFS creates a visual effect similar to a real-time computer game using a virtual competition with oneself.

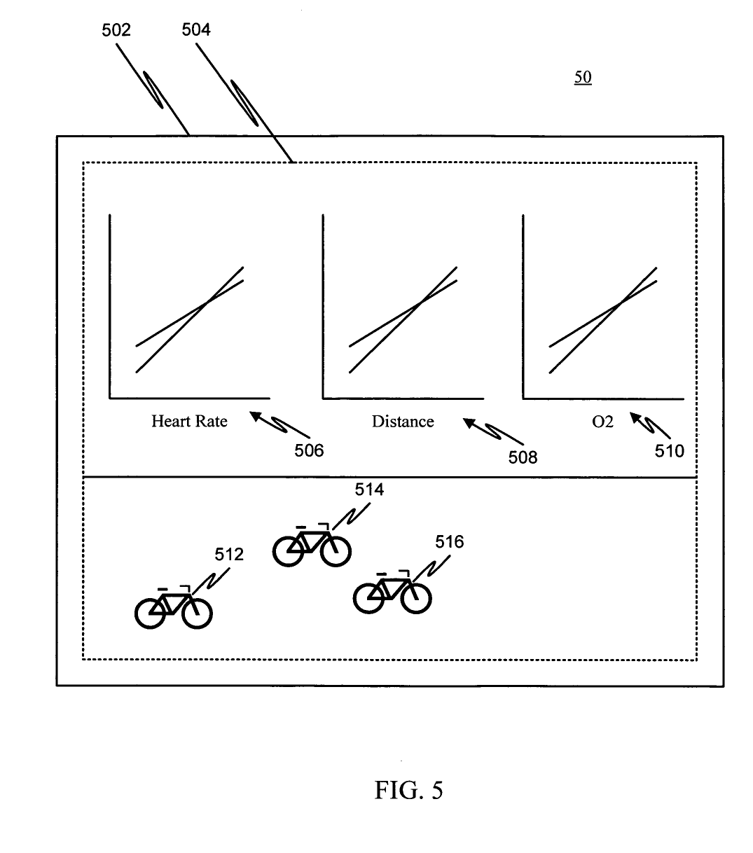

FIG. 5 is a diagram of an exemplary user interface in accordance with the present invention. In particular, a display system 50 comprises a visible screen portion 502, a touch screen portion 504, a heart rate graph 506, a distance graph 508, a blood oxygen level graph 510, a first virtual competitor 512, a second virtual competitor 514, and a graphical symbol of a current workout 516.

In operation, the heart rate graph 506, distance graph 508, and blood oxygen level graph 510 are responsive to data received from sensors attached to the user or to the exercise machine. The first virtual competitor 512 and second virtual competitor 514 are responsive to historical data retrieved from a database. The graphical symbol of a current workout 516 is responsive to current workout sensed data. The touch screen portion 504 is responsive to user input.

Further, the graphics necessary for the basic visual presentation and functionality of the graphical user interface are retained on, and generated by, the local GWFS. Because the required graphics images are known prior to run time, this is not a problem. It should be appreciated that many different competition environments, or ‘tracks’ could be easily provided as options to the user. The GWFS is configured so that communications between remote and local systems are in the form of conventional protocols, but may be implemented in later developed protocols. By transmitting only data, bandwidth requirements can be kept to a minimum for this functionality.

Conventional systems may provide methods for measuring, recording, and presenting summary information on exercise machine workouts. Known exercise bikes, for example, display (for a few seconds at the finish of the workout); the total number of miles cycled, total number of calories, burned, and total time duration. However, even if systems retained summary information such as that the current user covered 4.86 miles in the previous 15-minute workout, this would provide sub-optimal estimates for creating a virtual competition, and inadequate records for graphical presentations and real time feedback. To remedy this problem the local system of the current invention measures and records several aspects of each workout, in small increments, throughout the duration of the exercise activity.

For some workout variables, such as the pedaling rate and resistance, the GWFS measures and records one or more times per second, others such as pulse rate are recorded at larger intervals, such as once per minute. The GWFS uses straight-line extrapolation to smoothly bridge from one measurement point to the other for those workout variables that are recorded at larger time intervals. Tradeoffs and compromises may have to be made between the number of variables measured, the measurement interval, the number and size of shadow figures, number of dimensions, graphical views and other variables depending on system processing or memory resources. There are many permutations that work perfectly well, and the specific combination is not critical to the functioning of the invention, although at extremes it may affect the degree of realism perceived by users.

On some conventional equipment the variable known as ‘level’ is actually a parameter that varies resistance to the pedaling activity. In the real world this is equivalent to a gear on a bike. A higher gear is a higher resistance level, but covers more distance, per revolution. However, in the current art no accommodation is made of how the resistance variable impacts distance covered. In fact, on some known exercise bikes, pedaling for half an hour causes the display to read the same 10.8 miles covered each time, regardless of the resistance level or even revolutions per minute (RPM) of pedaling. Although varying the level and RPM parameters causes these machines to report different results for ‘calories burned’, it is quite clear that measures generated by some conventional systems are gross, unrealistic, and unreliable. To more realistically reflect distance covered in a manner similar to an actual bike ride in the real world, the GWFS calculates the distance covered using the RPM directly and by multiplying this by an increasingly large factor as the level is increased. Thus the distance covered after ten seconds of pedaling at 100 RPM at resistance level six will be 1.x times as much as the same time and RPM at resistance level five. Calculation of the correct relative distance ratios for each resistance level is obviously an iterative process requiring a different calibration that varies by specific type of exercise equipment, and even by model or version. One of ordinary skill in the current art understands that the specific multiplier for each resistance level is subject to some tweaking, and may even have to vary (ultimately) according to the specific machine brand and model. Nevertheless, the GWFS is designed to consistently and credibly maximize the accuracy of such variables to minimize user disconnectedness from the workout activity, in sharp contrast to methods used in the current art. In practical terms, all the system needs to do to provide a substantial improvement is to have the distance increase with increasing revolutions per minute, not to measure it precisely. The formula for calculating distance will inevitably be approximate initially and improve over time.

Although the conventional systems may provide sensory devices on handles attached to the equipment for measuring pulse rates, these methods are not considered sufficiently accurate or reliable. In a preferred embodiment, the GWFS utilizes a different device that receives sensory information from a source closer to the heart. The device is a sensory device worn like a strap over the shoulder, resting directly over the chest and receiving sensory input through the chest rather than the hands. Such devices are currently available commercially as stand-alone pulse rate measurement devices. This GWFS invention will utilize such devices but will integrate them into the system by directly wiring the sensory device to the GWFS. Those of ordinary skill in the art will recognize that, wireless technology will perform this function equally as well as a physical wiring. The methods to integrate data from this device are also relatively straightforward and well known in the current art. In this configuration the GWFS records the pulse rate continuously using the sensory device, but then instead of replacing previous measurements with new ones as in the current art, the GWFS retains and stores the recorded pulse rate every 60-120 seconds on the local system. As with new data on all parameters, the GWFS then immediately updates graphical presentations. Those of ordinary skill in the art will recognize that it may be desirable to also measure such variables as blood oxygen level, oxygen intake, respirations, and/or the like. These variables vary significantly during intense aerobic activity, and the means to measure, record, and display them are known to the current art, although they are typically utilized in sports medicine or hospital situations. The system and method of the present invention may enable the same level of sophistication to be achieved on exercise machines in a gym.

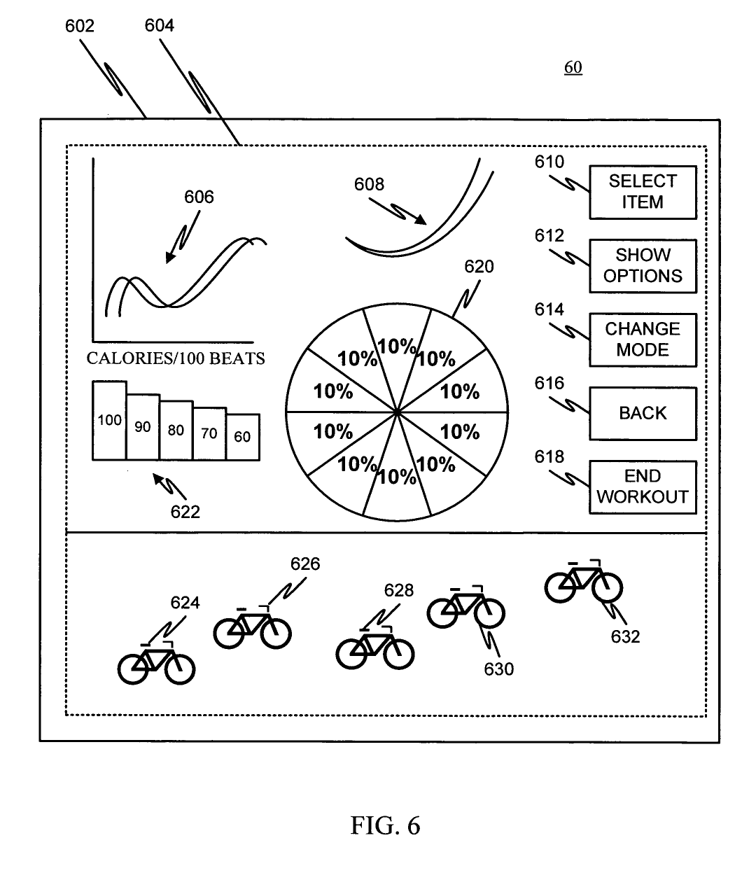

FIG. 6 is a diagram of an exemplary user interface in accordance with the present invention. In particular, a display system 60 comprises a visible screen portion 602, a touch screen portion 604, a calorie chart 606, a performance graph 608, a select item button 610, a show options button 612, a change mode button 614, a back button 616, an end workout button 618, an annual pie chart 620, a weekly improvement bar chart 622, a first virtual competitor 624, a second virtual competitor 626, a third virtual competitor 628, a fourth virtual competitor 630, and a fifth virtual competitor 632.

In operation, the select item button 610, show options button 612, change mode button 614, back button 616, and end workout button 618 are provided for receiving control input from a user. The calorie chart 606, performance graph 608, annual pie chart 620, and weekly improvement bar chart 622 are responsive to current and/or historical workout data. The first virtual competitor 624 represents a workout from ten days ago. The second virtual competitor 626 represents last week's average performance. The third virtual competitor 628 represents yesterday's workout. The fourth virtual competitor 630 represents today's workout. The fifth virtual competitor 632 represents the best performance of the user. The virtual competitors are responsive to historical and/or current data.

The buttons (610-618) are graphical symbols on a touch screen interface and respond to touch pressure from the user applied to the screen. While specific user interface elements are shown in FIG. 6, it should be appreciated that the user interface elements may be implemented in a variety of forms.

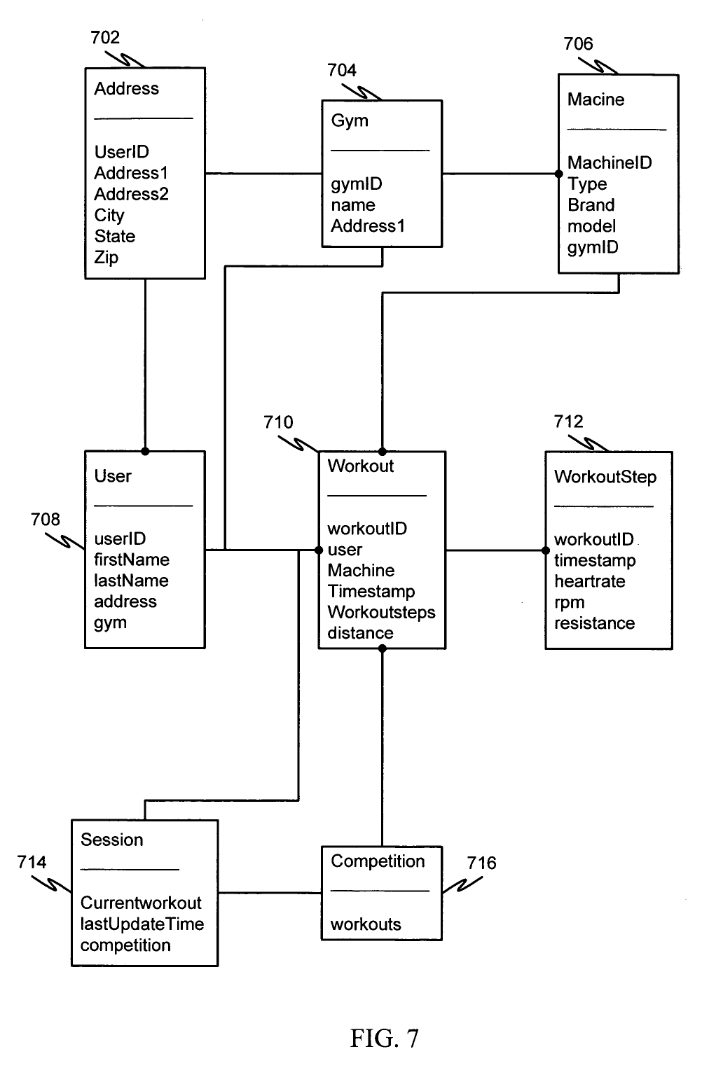

FIG. 7 is a block diagram of an exemplary software relational database design in accordance with the present invention. In particular, an address table 702 has a one-to-one relationship with a Gym table 704, a one-to-many relationship with a user table 708, and comprises six elements: 1) UserID, 2) Address1, 3) Address2, 4) City, 5) State, and 6) Zip. The Gym table 704 has a one-to-many relationship with a Machine table 706, the user table 708, and a workout table 710, and a one-to-one relationship with the address table 702, and comprises three elements: 1) GymID, 2) Name, and 3) Address. The Machine table 706 has a many-to-one relationship with the Gym table 704, a one-to-many relationship with the workout table 710, and comprises five elements: 1) MachineID, 2) Type, 3) Brand, 4) Model, and 5) GymID. The User table 708 has a many-to-one relationship with the Gym table 704, and the Address table 702, and a one-to-many relationship with the workout table 710, and comprises five elements: 1) UserID, 2) firstName, 3) lastName, 4) Address, and 5) GymID. The Workout 710 table has a many-to-one relationship with the Gym table 704, the User table 708, and the Machine table 706, and a one-to-many relationship with a WorkoutStep table 712, and comprises six elements: 1) workoutID, 2) userID, 3) machineID, 4) timeStamp, 5) WorkoutSteps, and 6) distance. The WorkoutStep table 712 has a many-to-one relationship with the Workout table, and comprises five elements: 1) workoutID, 2) timeStamp, 3) heartrate, 4) rpm, and 6) resistance.

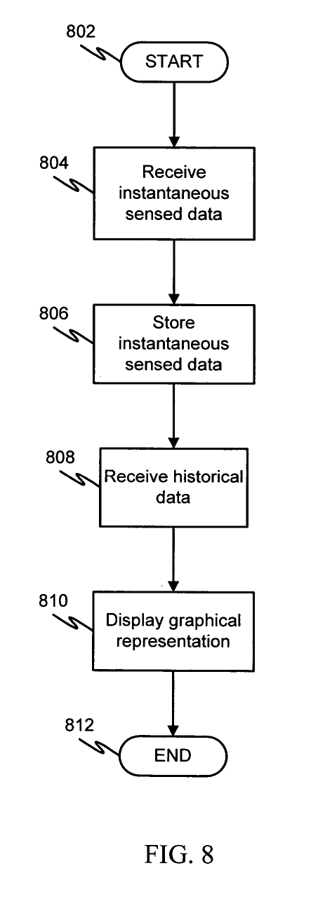

FIG. 8 is a flowchart of an exemplary method for providing graphical workout feedback in accordance with the present invention. In particular, the control sequence begins at step 802 and continues to step 804. In step 804, instantaneous sensor data is received by the graphical workout feedback system. Control then continues to step 806.

In step 806, the instantaneous data is stored. Control then continues to step 808. In step 808, historical data is retrieved. Control continues to step 810.

In step 810, the GWFS renders a graphical representation of the current workout instantaneous sensed data and the historical data. Control then continues to step 812 when the control sequence ends. However, the nature of the GWFS may require that control remain in a loop. In such an embodiment, control would continue from step 812 back to step 802 and the control sequence would begin again. Such a control loop may operate until terminated by a user, by power off, or by other source.

During the workout activities, all information relating to the workout is recorded and stored on the local system hard drive. As the workout proceeds, and as designated memory is allocated, the local system can periodically copy ‘a partial chunk’ of the current workout data and attempt to transmit it to the remote system to be stored in the database. This allows that storage to be freed up, if the local system threatens to run out. The optimal size or periodicity of these transmissions is between 1-5 minutes of (completed) workout data, depending on the connectivity, usage, and other factors. At the conclusion of the workout, during periods of ‘down time’, and based on availability of connectivity, the local system communicates with the remote system to insure that all data related to complete workouts have been received by the remote system and stored on the remote database. After confirmation of receipt from the remote location, the local system deletes the local copies of workout data on the hard drive, and releases the storage, whether it is needed or not.

In a preferred embodiment, the GWFS segments the visual display into three parts. It allocates the ongoing virtual competition to one area of the visual display, graphs of workout data to a second area, and user input icons to a third area. Optimally, the far right part of the visual display screen (a column approximately 20-25% of screen width) be allocated to user input icons, and the remaining portion of the visual display is segmented by a horizontal line approximately ⅓ of the way down from the top. In the optimal configuration the virtual competition is presented in the larger ⅔ portion at the bottom of the screen.

The graphical workout feedback methods and systems, as shown in the above figures, may be implemented on a general-purpose computer, a special-purpose computer, a programmed microprocessor or microcontroller and peripheral integrated circuit element, and ASIC or other integrated circuit, a digital signal processor, a hardwired electronic or logic circuit such as a discrete element circuit, a programmed logic device such as a PLD, PLA, FPGA, PAL, or the like. In general, any process capable of implementing the functions described herein can be used to implement a system for graphical workout feedback according to this invention.

Furthermore, the disclosed system may be readily implemented in software using object or object-oriented software development environments that provide portable source code that can be used on a variety of computer technologies and platforms. Alternatively, the disclosed system for intervisibility determination may be implemented partially or fully in hardware using standard logic circuits or a VLSI design. Other hardware or software can be used to implement the systems in accordance with this invention depending on the speed and/or efficiency requirements of the systems, the particular function, and/or a particular software or hardware system, microprocessor, or microcomputer system being utilized. The graphical workout feedback methods and systems illustrated herein can readily be implemented in hardware and/or software using any known or later developed systems or structures, devices and/or software by those of ordinary skill in the applicable art from the functional description provided herein and with a general basic knowledge of the computer and mark-up language arts.

Moreover, the disclosed methods may be readily implemented in software executed on programmed general-purpose computer, a special purpose computer, a microprocessor, or the like. In these instances, the systems and methods of this invention can be implemented as program embedded on personal computer such as JAVA® or CGI script, as a resource residing on a server or graphics workstation, as a routine embedded in a dedicated encoding/decoding system, or the like. The system can also be implemented by physically incorporating the system and method into a software and/or hardware system, such as the hardware and software systems of an image processor.

It is, therefore, apparent that there is provided in accordance with the present invention, systems and methods for providing graphical workout feedback. While this invention has been described in conjunction with a number of embodiments, it is evident that many alternatives, modifications and variations would be or are apparent to those of ordinary skill in the applicable arts. Accordingly, applicants intend to embrace all such alternatives, modifications, equivalents and variations that are within the spirit and scope of this invention.

1. A method for providing a visual gauge of fitness progress to a user of a cardiovascular exercise machine comprising:
receiving instantaneous sensed data during a workout, the instantaneous data sensed by one or more sensors and representative of at least one workout parameter;
storing the instantaneous sensed data as a function of time;
receiving stored historical data from one or more previous workouts, the historical data representative of the workout parameter as a function of time; and
displaying a graphical representation of the instantaneous sensed data juxtaposed with the historical data on a display so the progress toward a desired fitness level can be gauged.

2. The method of claim 1, wherein the workout parameter is a distance measurement, and wherein the graphical representation depicts at least one virtual competitor in a virtual environment so that a relative position of the virtual competitor on the display is a function of the instantaneous sensed data and the historical data.

3. The method of claim 1, wherein the graphical representation includes at least one graph displaying the instantaneous sensed data and the historical data.

4. The method of claim 3, wherein the workout parameter is a physiological parameter.

5. The method of claim 4, wherein the physiological parameter is a pulse.

6. The method of claim 4, wherein the physiological parameter is a blood-oxygen level.

7. The method of claim 4, wherein the physiological parameter is a respiration rate.

8. The method of claim 1, further comprising:
maintaining the historical data in a data repository which includes historical data for one or more users,
wherein the step of receiving historical data further includes requesting the historical data from the data repository for the user via a user identifier.

9. The method of claim 8, wherein the data repository is in a remote location, and the receiving step occurs over a network.

10. The method of claim 8, further comprising:
storing the instantaneous sensed data in the data repository as historical data for a future workout.

11. The method of claim 1, wherein the instantaneous data is recorded in intervals of less than one second.

12. The method of claim 1, wherein the historical data describes an average of the workout parameter from the previous workouts.

13. A system for providing a visual gauge of fitness level progress to a user of a cardiovascular exercise machine, said system comprising:
at least one sensor to sense an instantaneous value of at least one workout parameter;
first means for storing historical data from at least one previous workout, said historical data representative of said at least one workout parameter as a function of time;
second means for storing instantaneous sensed data as a function of time;
a processor responsive to the instantaneous sensed data and the historical data for rendering a real-time graphical representation; and
a display device to display the rendered real-time graphical representation of the instantaneous sensed data juxtaposed with the historical data so the progress toward a desired fitness level can be gauged.

14. The system of claim 13, further comprising communication means for communicating with a remote data repository having the historical data for one or more users.

15. The system of claim 13, wherein the workout parameter is a distance measurement, and wherein the graphical representation depicts at least one virtual competitor in a virtual environment so that a relative position of a virtual competitor on the display device is a function of the instantaneous sensed data and the historical data.

16. The system of claim 13, wherein the graphical representation includes at least one graph displaying the instantaneous data and the historical data.

17. The system of claim 13, wherein the workout parameter is a physiological parameter of the user.

18. The system of claim 17, wherein the physiological parameter is a pulse.

19. The system of claim 17, wherein the physiological parameter is a blood-oxygen level.

20. The system of claim 17, wherein the physiological parameter is a blood-oxygen level.

21. The system of claim 13, wherein the instantaneous data is recorded in intervals of less than one second.

22. A cardiovascular exercise machine comprising:
a mechanism for increasing cardiovascular activity of a user of the exercise machine;
at least one sensor to sense an instantaneous value of at least one workout parameter;
first means for storing historical data from at least one previous workout representative of the workout parameter as a function of time;
second means for storing instantaneous sensed data as a function of time;
a processor responsive to the instantaneous sensed data and the historical data for rendering a real-time graphical representation; and
a display device to display the rendered real-time graphical representation of the instantaneous sensed data juxtaposed with the historical data so the progress toward a desired fitness level can be gauged.
